(19) United States
(12) Patent Application Publication
(10) Pub. No.: US 2025/0282277 A1
(43) Pub. Date: Sep. 11, 2025

(54) FLEXIBLE AIR CUSHION SYSTEM FOR SECURING LOADS IN CARGO HOLDS

(71) Applicant: Enrico KRIENING, Herzberg/Elster (DE)

(72) Inventor: Enrico KRIENING, Herzberg/Elster (DE)

(21) Appl. No.: 19/067,469

(22) Filed: Feb. 28, 2025

(30) Foreign Application Priority Data
Mar. 7, 2024 (EP) 24162065

(51) Int. Cl. B60P 7/06; B60P 7/135

(52) U.S. Cl. CPC B60P 7/065; B60P 7/135

(57) ABSTRACT

The invention relates to load securing in cargo holds (for example of transport vehicles such as lorries/trucks, transporters, in semi-trailers or of loading containers) and a flexible system provided for this purpose. Described is an air cushion system for load securing in cargo holds, which includes:
at least one rail (1) for fastening horizontally at the top or vertically at the side in the cargo hold,
at least one inflatable air cushion (2) connected to the rail, each with a volume of 0.01 to 10 metres³,
wherein the air cushion has at least 2 eyelets and/or hooks (4) on each of those outer edges which are not connected to the rail or rails (3).

### CROSS REFERENCE TO RELATED APPLICATIONS

This application claims priority to European patent application no. EP24162065.7, filed on Mar. 7, 2024, the entire contents of which are hereby incorporated by reference herein.

### BACKGROUND OF THE INVENTION

The invention relates to load securing in cargo holds, for example lorries (LKW), and a flexible system provided for this purpose. “Lorries” are also abbreviated to LKW in the document.

Loosely inflatable dunnage bags for load securing and the associated quick-fill guns as well as the use of air cushions for lorries are well known. These can be packed between the cargo and inflated. Pre-inflation is also conceivable.

WO 2008/086584 A1 describes side curtains for lorry or trailer superstructures for securing the load against falling onto the road. Securing inside and between the individual items of cargo is not possible.

Also known are box-shaped fixtures for lorries for bulk goods, such as in U.S. Pat. No. 4,124,136 A or BR 9202694 A, or lining devices for load containers, such as in EP 0287640 A1. It is therefore not possible to secure individual items of cargo to each other.

The task of the invention is to provide a system for securing loads in cargo holds, which offers the securing of the loads to each other. It should also be possible to prevent slipping during the journey. The securing should be secure but flexible, i.e. quickly adaptable. This is because when part of the load is reloaded or unloaded, it should be possible to quickly reattach the securing system and adapt it to the new load volume and the occupancy of the cargo hold, respectively.

This adjustment should not require a great deal of force, as is necessary when using belts.

The problem is solved with the features of the independent patent claims. Preferred embodiments are described in the dependent subclaims.

### BRIEF SUMMARY OF THE INVENTION

The invention relates to load securing in cargo holds (for example of transport vehicles such as lorries/trucks, transporters, in semi-trailers or of loading containers) and a flexible system provided for this purpose.

Described is:

An air cushion system for load securing in cargo holds, comprising:
at least one rail (1) for fastening horizontally at the top or vertically at the side in the cargo hold,
at least one inflatable air cushion (2) connected to the rail, each with a volume of 0.01 to 10 metres³,
wherein the air cushion has at least 2 eyelets and/or hooks (4) on each of those outer edges which are not connected to the rail or rails (3).

### BRIEF DESCRIPTION OF DRAWINGS

FIG. 1 and FIG. 2 show extracts of three different embodiments of the invention in variants for a lorry:

FIG. 1 and FIG. 2/left: two embodiments, each with one rail 1.

A variant of the invention according to FIG. 2/left has incisions 5 so that air cushion tongues 6 are formed.

FIG. 2/right: another embodiment with two rails 1 as roll-up rails (for simplification, the eyelets or hooks 4 are not shown).

### DETAILED DESCRIPTION OF INVENTION

The object of the invention is an air cushion system for securing loads in cargo holds (for example of transport vehicles such as lorries/LKW, transporters, in semi-trailers or of loading containers), comprising:
At least one rail for fastening (top horizontally or side vertically) in the cargo hold,
at least one inflatable air cushion connected to the rail, each with a volume of 0.01 to 10 metres³,
wherein the air cushion has at least 2 eyelets (i.e. annular edge-reinforced openings) and/or hooks on each of those outer edges which are not connected to the rail or rails.

“Load securing in cargo holds” means securing the cargo in the cargo hold of the respective transport vehicle against unintentional slipping during the transport.

An “air cushion system” within the meaning of the invention is therefore: rail(s) with air cushion(s). It is quite possible to arrange several such air cushion systems one behind the other in the cargo hold, each system comprising at least one rail and the associated air cushion, according to the invention.

Load securing recognisably involves the securing of goods which (in contrast to bulk goods) have a volume of at least 0.008 m³, for example at least 0.2 m×0.2 m×0.2 m.

“Top” or “side” (with regard to the fastening of the rail in the cargo hold) refers to the orientation of the cargo hold during transport (i.e. while the associated transport vehicle is travelling), i.e. in its upright, i.e. mobile, state. “Top” therefore stands for a “horizontal” orientation and “at the side” for a “vertical” orientation. “Bottom” stands for the direction facing the road, “top” for the direction facing away from the road. For fastening, the rail should have hooks (hook-shaped), projections (straight) or clamping surfaces at both ends. The rail can be a fixed-length bar or a telescopic rail. It can also have a roll-up function and thus be designed as a roll-up rail so that the connected air cushion can be rolled up within the rail.

The “inflatable air cushion” has a recognisably airtight design. It essentially has corners at an angle of 90°, i.e. it can be rectangular or square. The term “air cushion” also includes non-inflatable edge areas, but these can usefully have a maximum width of 20 cm. It is also possible that several air cushions are connected to the same rail (i.e. attached to it). The thickness of each inflatable air cushion (when inflated) should preferably not exceed 1 metre or even 50 cm. The lower limit should preferably not be less than 20 cm.

The “eyelets or hooks” are used for fastening in the cargo area by means of hooks (in the case of the eyelets) or by means of cords (in the case of the hooks). This means that hooks can be inserted into the two eyelets or cords can be attached to the two hooks.

Another object of the invention is the use of the air cushion system according to the invention for securing loads in a cargo hold.

### Advantages

The advantage of the invention in this described form is that it allows loads to be secured to each other. Slipping during the journey is prevented.

Another advantage is that it can be flexibly secured. This means that quick adaptations are possible. This is because when part of the load is reloaded or unloaded, the securing can be quickly reattached and adapted to the new load volume and the occupancy of the loading bays.

A further advantage is that readjustment to the changing occupancy of the loading bays during each loading process is possible without great effort, as there is no need for belts. Instead, the changed occupancy situation can be countered by changing the inflation of the air cushions and by changing the fastening by means of the eyelets and hooks, respectively. Parts of the air cushion system according to the invention can be put under tension, while at the same time other parts hang loosely downwards.

Furthermore, it is even possible that one part of the air cushion of such an air cushion system runs perpendicular to the direction of travel (i.e. perpendicular to the length of the cargo hold) and another part of the same air cushion runs in a different direction, i.e. that “kinks” are possible so that an air cushion (e.g. attached to the floor by means of the eyelets or hooks) runs “around the corner”—whereby the rail, e.g. located at the top, is straight and has no kink. This saves effort (compared to loose inflatable stowage cushions from the state of the art) when bringing under tension (inflating).

### Preferred Embodiments

The cargo hold is preferably a lorry or transporter cargo hold or a cointainer.

In a preferred embodiment of the invention, the volume of the air cushion is 7 m³ (as for example with the dimensions: H×W×Thickness=2.5 m×5 m×0.5 m) or 4 m³ (as for example with H×W×Thickness=2.5 m×2.5 m×0.5 m), ±10% of the volume in each case. Preferred ranges could be 4-10 m³, even 3-8 m³, 4-7 m³ etc.

In a preferred embodiment, the air cushion has at least 3 eyelets or hooks on each of the outer edges that are not connected to the rail or rails, particularly preferably 3-6, or even exactly 3.

In a preferred embodiment of the invention, the distance between adjacent eyelets and hooks, respectively, is 15 cm to 1.50 m, or also 15 cm-1 m or even 15 cm to 50 cm.

In the invention, the rail is preferably a straight rail, most preferably a straight telescopic rail (i.e. it is adjustable in length in both directions and comprises a locking mechanism, for example a clamping screw or clamping lever, which presses on the inside of the rail to lock it, or a engaging bolt, which pushes through a hole in the inside of the rail).

In a preferred embodiment of the invention, the air cushion comprises a compressed air connection for connection to the compressed air system of a lorry, transporter or the respective transport vehicle (for example to the outlet on the loading compressor).

In a preferred embodiment of the invention, the connection between the rail and the air cushion is selected from a welded connection, an adhesive connection, a seam connection, a zip fastener connection, a hook-and-loop fastener connection, a riveted connection (with aluminium rivets, for example) and a screw connection. In any case, it must be designed to be tension-resistant so that the air cushion cannot tear off the rail(s) even during inflating the air cushion when the resulting tensile forces occur. To reinforce the rivet or screw connection, it is conceivable to reinforce it, for example, with a meltable metal (preferably Cu, Al or Fe) or a meltable metal alloy (preferably bronze or brass) in order to achieve even better tear resistance. This would additionally secure rivets and screws to the rail, respectively.

In the case of a welded connection, the air cushion material is connected to the rail by means of fusion (the air cushion material is then a meltable polymer). The rail could be made of the same polymer, but metal is also possible.

With an adhesive connection, the air cushion is glued to the rail (favourable for air cushions made of several different layers, such as fabric with a polymer coating).

With a seam connection, the air cushion is sewn to the rail, i.e. the air cushion can have eyelets on the side facing the rail, by means of which it is connected to the rail using rope or cables. However, sewing is also possible without eyelets if the sewing takes place in a non-inflatable edge area.

With a zip fastener connection, there is a zip on the edge of the air cushion facing the rail. In this variant, the rail also has a zip fastener, for example by means of a fabric cover running around the rail (encasing the rail) to which a zip fastener is sewn.

In the case of a screw connection, for example, the air cushion can be placed on the rail (with its edge area) and connected to the rail using screws, preferably self-tightening/thread-forming screws.

The advantage is a tension-resistant connection between the rail and air cushion. The zip fastener connection in particular allows the air cushion on the rail to be changed quickly (e.g. if the air cushion is leaking) or enables that only half of the rail to be covered with air cushion (in relation to the length of the rail).

In preferred embodiments of the invention, the rail material is selected from polymer, metal, wood, fibre composite and carbon fibre. Fibre composite material and carbon fibre in particular have the advantage of very low weight combined with high strength.

An equally preferred embodiment of the invention is characterised in that the rail:
is a (corrosion-resistant) metal rail made of stainless steel, galvanised steel or aluminium, and/or
has a length of 2.40-2.50 m, and/or
has a square, rectangular or round profile.

It is particularly preferable if the rail:
is a metal rail made of stainless steel, galvanised steel or aluminium, and/or
has a length of 2.40-2.50 metres.

In the case of a telescopic rail, a round profile is preferred, but a square profile, as mentioned above, is also possible.

A round rail profile can withstand more tensile forces. The rail is preferably hollow, regardless of the material. A solid profile would only be possible with an aluminium rail. Solid profile means that the rail is not hollow, but filled.

The advantage of the length mentioned is that the air cushion system is well suited for standard cargo holds. Steel and aluminium provide excellent strength, respectively.

In an equally preferred version of the air cushion system, the material of the air cushion has at least one layer of fabric with a plastic coating on the inward-facing sides and the air cushion has a non-inflatable edge region (circumferential) of 3-20 cm width (particularly preferably 6-20 cm or even 2-20 cm or 6-12 cm), within which all of the eyelets or hooks are arranged. Advantageously, in this case static friction between the plastic of different air cushions or between air cushions and other objects is avoided due to the outer layer of fabric.

However, an embodiment is also possible in which the plastic coating is located on the outward-facing surfaces of the fabric layer of the air cushion. The advantage of such an internal fabric layer is reduced frictional forces on the airtight material (usually plastic) in the event of friction, especially when the air cushion is not inflated, in which case it often hangs between the still loosely stored loads and can be squeezed.

The circumferential non-inflatable edge area with the eyelets and hooks, respectively, ensures that the tensile forces acting on the eyelets/hooks are transferred evenly to both sides of the air cushion and that one half of the eyelet on one side surface of the air cushion does not have to withstand more tensile force than the surface on the other side of the air cushion.

In a further preferred embodiment of the invention, the rail (and also any further rails of this air cushion system) are roll-up rails, comprising a retraction device for rolling up and unrolling the air cushion, which exerts a retraction force on the air cushion and enables the manual unrolling of the air cushion (also called pulling out) out of the rails against the retraction force (expediently in the not yet fully inflated state).

Retraction devices can be, for example: a metal worm (automatic worm under tension, such as with electric cables of hoovers) or by means of rachets (gear wheel with acute-angled teeth and a blunt hook that engages in each individual tooth of the gear wheel so that the wheel cannot be turned in the opposite direction). The necessary tension can be created, for example, by means of an electric motor or with a cable pull to be operated manually, with which the air cushion is put under tension. The retraction device then ensures that the tension is maintained.

The advantage of this is that the air cushions can be attached very quickly around the load and at the same time unused air cushions can be easily stowed away (for example at the top of a rail fastened horizontally or at the side of a rail fastened vertically).

It is also preferred if, in the invention, the rail has a round or an angular cross-section, selected from rectangular and square, and if the air cushion has a volume of 0.45-4 m³, particularly preferably 0.6-2m³ or also 0.75-1m³. Such a rectangular or square cross-section is particularly preferred. The advantage of this embodiment is that it is particularly suitable for common cargo and for the associated requirements for securing to each other.

It is also preferable in the invention if two (or even three) air cushions are connected to each rail. This corresponds to a preferred embodiment of the air cushion system with at least two (or particularly preferably even three) air cushions of essentially the same size, which are connected to the rail at the same positions on the rail, and thus parallel to one another, in the direction of view along the rail.

For example, in the case of a rail mounted horizontally at the top, two or three air cushions (different widths are also possible) would hang on one and the same rail, so that one air cushion can be pushed forwards and the other backwards or even vertically into a gap between other cargo items. Preferably, however, the properties of the air cushion according to the invention are the same for both (or the three) air cushions) on one rail.

“Essentially the same size” means that the base areas of the two parallel air cushions are at least 80% the same.

In a preferred embodiment of the invention, there is a rail on each of two opposite outer edges of the air cushion. Thus, for example, in the case of horizontal alignment of both rails in the cargo hold, one could be fastened at the top and one at the bottom of the cargo hold.

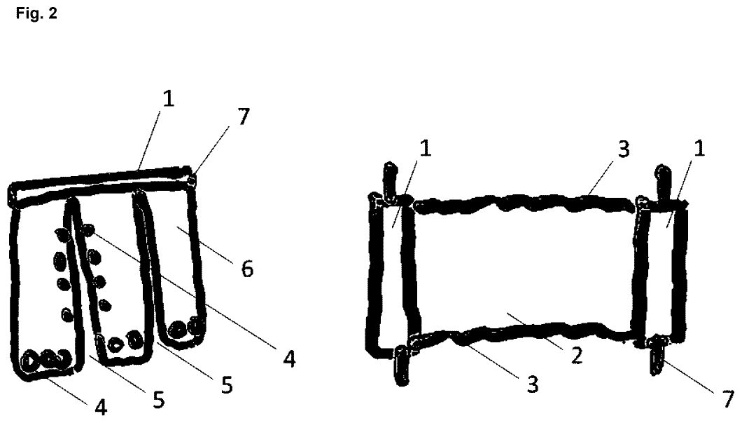

The following describes embodiments that correspond conceptually to a variant with incisions, as shown as an example in FIG. 2/left:

In a preferred embodiment of the invention, it is the air cushion system according to the invention, with a rail for fastening horizontally at the top in the cargo hold, wherein the air cushion is divided into at least two air cushion tongues by means of incisions (more precisely: at least one incision) of at least 70% of the length of the air cushion (viewed in a direction starting from the side opposite the rail in the direction of the rail). Accordingly, the incisions extend from the outer edge of the air cushion opposite the rail in the direction of the rail. It makes sense for this embodiment to have only one rail.

“At least 70% of the length” does not mean that the incision must run completely through the length of the air cushion, as the resulting air cushion tongues together are still connected to the rail at the upper end.

“Length” here recognisably refers to the dimension of the air cushion from bottom to top, i.e. in the direction of the height of the cargo hold (the directions during transport; also including any edge areas of the air cushion.

For example, a length of the incisions of 70-98% of the length of the air cushion is recommended, or 70-90% or even 80-90%.

However, in the case of a zip fastener connection between the rail and the air cushion (as described above for another preferred embodiment), it is possible that the incision runs almost completely through the air cushion, so that both air cushion tongues are only held together by the part of the zip fastener on the side of the air cushion (if the zip fastener is counted as part of the air cushion).

It is particularly preferable to have two incisions so that there are three air cushion tongues. 2-3 incisions are also advantageous.

The minimum contiguous area of an air cushion according to the invention (or even of such an air cushion tongue of the aforementioned embodiment) is 30 cm×200 cm, i.e. the length of one side of the air cushion (or correspondingly the width of a single air cushion tongue, if there are incisions) is at least 30 cm and the length of the adjacent side is at least 200 cm.

The advantage of the embodiment with incision and air cushion tongues is that different empty spaces in the cargo hold can be filled particularly effectively starting from a single rail—these empty spaces do not have to be in one plane—because the air cushion tongues can point in different directions. Depending on the positioning of the individual load, the air cushion tongues can be aligned separately by attaching the eyelets and hooks, respectively, to the loading area floor (e.g. of a lorry) or to the sides of the loading area—forwards, backwards or in all other directions. Empty air spaces within the cargo hold can thus be reduced.

In a particularly preferred variant of the above-mentioned embodiment with an incision and at least two air cushion tongues, each of the air cushion tongues can be inflated separately and is therefore sealed off from the other in terms of its volume. Ideally, each air cushion tongue preferably has its own air connection for inflating separately.

The advantage of the separate inflatability is that the different sizes of the empty spaces (i.e. the different volumes) can be filled as required by the air cushion tongues.

It is also particularly preferable (in this embodiment with incision and at least two air cushion tongues) if there are at least 3 eyelets or press studs for connecting individual air cushion tongues along those sides of all air cushion tongues that face the incisions (i.e. the eyelets run along the incisions on the two sides of the adjacent air cushion tongues).

The advantage of this is that if the empty spaces are in one plane, or at least close together, the air cushion tongues can be quickly reconnected.

“Press studs” are known to be fasteners/fastening means with two small, round parts, one of which is provided with a recess and the other with a matching head. They are sewn or riveted to opposite sides of the material and pressed together to close. To ensure that the air cushions can be inflated, these eyelets and press studs, respectively, are also connected to the air cushion tongue in an airtight manner or are located in non-inflatable (i.e. sealed) edge areas (which should be present on all outer edges of the air cushion tongues that are not connected to the rail).

It is also particularly preferable (in the above-mentioned embodiment with incision and at least two air cushion tongues) if there are two incisions in the air cushion and thus three air cushion tongues.

In further preferred embodiments of the invention, the air cushion or the individual air cushion tongues have a width (width in the direction of the width of the cargo hold) of 115-195 cm (favourable for use with Euro pallets which have a base area of 120×190 cm), or preferably even a width of 120 cm±10%, or 190 cm±10%. For one-way pallets (base area 60 cm×80 cm or 120 cm×80 cm or 40 cm×60 cm), a width of the air cushions or air cushion tongues of 50 cm±10% or 70 cm±10% is particularly suitable.

The following describes embodiments that correspond conceptually to a variant with two rails and air cushions in between, as shown as an example in FIG. 2/right:

In a further embodiment of the invention, the air cushion system has two rails for fastening vertically at the side (laterally) in the cargo hold, wherein the air cushion is connected to the (two) rails with two of its opposing sides. This means that the air cushion is connected on one side to one rail and on the other side to the other rail. Both are the same type of connection, which can be selected, for example, as described above.

In this version, the rail length corresponds to the height of a lorry cargo hold, i.e. approximately 2.30-2.50 m, or even 2.40-2.50 m, or even 2.45-2.50 m. For higher haulage lorries it could even be 2.40-2.80 m, but for 3.5 t vehicles only a maximum of 1.80 m and for transporters (vans) more like 80 cm-100 cm. In the case of two rails, “vertically at the side (laterally)” in the sense of the invention here means that these can be used sensibly on the left and right in the cargo hold (but also at the front and rear or even diagonally offset, i.e. on a diagonal of the cargo hold surface).

Especially preferable is a combination of this embodiment with two rails and air cushion “in between” with that embodiment described above, in which the rails are roll-up rails, comprising a retraction device for rolling up and unrolling the air cushion, which exerts a retraction force on the air cushion and enables the manual unrolling of the air cushion from the rails against the retraction force, is particularly advantageous.

The advantage of this combination is that one rail when disconnecting from the cargo hold can be put to the other rail, which is still attached, and in this moment the air cushion (ideally when not fully inflated) automatically rolls up into the rails, creating space for loading and unloading the cargo hold.

It is particularly preferable if, in the above-mentioned embodiment (with two rails and the air cushion in between), vertical reinforcing struts are provided within the air cushion, which run parallel to the rails connected to the air cushion and which run inside the air cushion. The advantage of this embodiment is that the air cushion is reinforced so that it retains its shape even if it is not inflated during use, for example with very light goods. The air cushion then does not sag downwards at the upper edge area, but is “stretched” by the reinforcing struts.

The following can be considered as reinforcing struts for example: metal wires, plastic rods or glass fibre rods (made of glass fibre composite material), all three types with a diameter of 1 mm to 1 cm, or also 1 mm-8 mm, or 1 mm-5 mm.

The distance between the reinforcing struts in the air cushion can be 10-40 cm, for example (or 10-30 cm, even 15-25 cm).

Here, it is particularly preferable if there is an eyelet at each end of a reinforcing strut that also runs through the air cushion material. In this embodiment, these eyelets in the reinforcing strut thus correspond to the variants of the invention with eyelets. The advantage is that the force applied to the air cushion can be transferred to the reinforcing strut by means of the eyelet. This makes it less likely that the air cushion will tear if the tensile force is too strong.

Unless otherwise specified, it is advisable to combine the various embodiments with each other.

In the following, the invention will be explained in more detail with reference to several preferred embodiments. They are not intended to limit the invention.

### EXECUTION EXAMPLES

### Execution Example 1

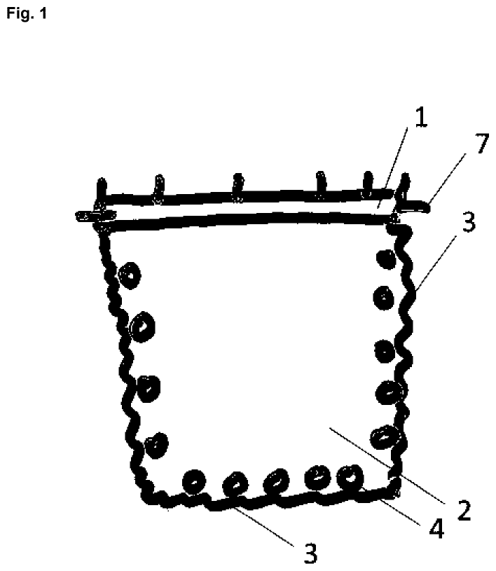

Execution example 1 corresponds to FIG. 1, where the air cushion material is polyethylene with a cotton layer (on the outside in each case). Eyelets 4 are used. The rail 1 is a round roll-up rail. It has protruding projections at both ends for fastening in the lorry cargo hold.

### Execution Example 2

Execution example 2 corresponds to FIG. 2/left and has a rail 1. The air cushion 2 has two incisions 5 with 98% of the air cushion length.

A zip fastener connection was used to connect the air cushion 2 to the rail 1 (not shown). Rail 1 is round. It is covered with a fabric to which one part of the zip fastener is attached.

### Execution Example 3

Execution example 3 corresponds to FIG. 2/right with two rails 1 as roll-up rails. Eyelets (not shown) are present.

### REFERENCE SIGN

1 Rail
2 Air cushion
3 Such outer edges that are not connected to the rail
4 Eyelets or hooks
5 Incisions
6 Air cushion tongues
7 Protrusions, hooks or clamping surfaces (for fastening the rail)

1. An air cushion system for securing loads in cargo holds, comprising:
at least one rail (1) for fastening horizontally at the top or vertically at the side in the cargo hold,
at least one inflatable air cushion (2) connected to the rail, each with a volume of 0.01 to 10 metres³,
wherein the air cushion has at least 3 eyelets and/or hooks (4) on each of those outer edges which are not connected to the rail or rails (3)
wherein the connection between the rail (1) and the air cushion (2) is selected from a welded connection, an adhesive connection, a seam connection, a zip fastener connection, a hook-and-loop fastener connection, a riveted connection and a screw connection, and
wherein all rails (1) are roll-up rails, comprising a retraction device for rolling up and unrolling the air cushion (2), which exerts a retraction force on the air cushion and enables the manual unrolling of the air cushion from the rails against the retraction force.

2. The air cushion system according to claim 1, wherein the rail:
is a metal rail made of stainless steel, galvanised steel or aluminium, and/or
has a length of 2.40-2.50 metres.

3. The air cushion system according to claim 1, wherein the material of the air cushion (2) has at least one fabric layer with a plastic coating on the inward-facing sides and wherein the air cushion has a non-inflatable edge region of 6-20 cm width all round, within which all the eyelets or hooks are arranged.

4. The air cushion system according to claim 1, wherein the rail has an angular cross-section selected from rectangular and square, and wherein the air cushion has a volume of 0.45-4 meters³.

5. The air cushion system according to claim 1, with at least two air cushions of substantially equal size, which are connected to the rail at equal positions on the rail, and thus parallel to each other, in the direction of view along the rail.

6. The air cushion system according to claim 1, wherein the rail is a straight telescopic rail.

7. The air cushion system according to claim 1, with one rail (1) for fastening horizontally at the top in the cargo hold, wherein the air cushion is divided into at least two air cushion tongues (6) by means of incisions (5) of at least 70% of the length of the air cushion, starting from the side opposite the rail in the direction of the rail.

8. The air cushion system according to claim 7, wherein each air cushion tongue (6) is inflatable separately and is thus closed off from the other in terms of its volume.

9. The air cushion system according to claim 7, wherein along such sides of all air cushion tongues (6), which face towards the incisions (5), at least 3 eyelets or press studs are provided for connecting individual air cushion tongues.

10. The air cushion system according to claim 7, with two incisions (5) and thus three air cushion tongues (6).

11. The air cushion system according to claim 1, with two rails (1) for fastening vertically at the side in the cargo hold, wherein the air cushion (2) is connected to both rails with two of its opposite sides.

12. The air cushion system according to claim 11, wherein vertical reinforcing struts are provided inside the air cushion (2), which run parallel to the rails attached to the air cushion and in the interior of the air cushion.

13. The air cushion system according to claim 12, wherein there is an eyelet at each end of the reinforcing struts, these eyelets extending through the air cushion material.

14. The air cushion system according to claim 2, wherein the material of the air cushion (2) has at least one fabric layer with a plastic coating on the inward-facing sides and wherein the air cushion has a non-inflatable edge region of 6-20 cm width all round, within which all the eyelets or hooks are arranged.

15. The air cushion system according to claim 2, wherein the rail has an angular cross-section selected from rectangular and square, and wherein the air cushion has a volume of 0.45-4 meters³.

16. The air cushion system according to claim 3, wherein the rail has an angular cross-section selected from rectangular and square, and wherein the air cushion has a volume of 0.45-4 meters³.

17. The air cushion system according to claim 16, with at least two air cushions of substantially equal size, which are connected to the rail at equal positions on the rail, and thus parallel to each other, in the direction of view along the rail.

18. The air cushion system according to claims 17, wherein the rail is a straight telescopic rail.

19. The air cushion system according to claim 18, with one rail (1) for fastening horizontally at the top in the cargo hold, wherein the air cushion is divided into at least two air cushion tongues (6) by means of incisions (5) of at least 70% of the length of the air cushion, starting from the side opposite the rail in the direction of the rail.

20. The air cushion system according to claim 19, wherein each air cushion tongue (6) is inflatable separately and is thus closed off from the other in terms of its volume.
